(19) United States
(12) Patent Application Publication
(10) Pub. No.: US 2019/0325425 A1
(43) Pub. Date: Oct. 24, 2019

(54) Reusable Cup Sleeve with Scannable Payment System

(71) Applicant: Cameron Khoury, Chicago, IL (US)

(72) Inventor: Cameron Khoury, Chicago, IL (US)

(21) Appl. No.: 16/033,594

(22) Filed: Jul. 12, 2018

Related U.S. Application Data
(60) Provisional application No. 62/659,405, filed on Apr. 18, 2018.

(51) Int. Cl. G06Q 20/32; B65D 81/38; G06K 19/06

(52) U.S. Cl. CPC G06Q 20/3278; G06K 19/06028; B65D 81/3876

(57) ABSTRACT

A reusable cup sleeve having a sleeve movable between a folded and unfolded configuration, wherein the unfolded configuration includes a tubular member, wherein the tubular member defines an open upper end, an open lower end and a cavity therethrough. The cavity is sized to receive a beverage container therein. The reusable cup sleeve also has a gripping surface to secure a user's hold on the beverage container. Indicia is disposed on an external surface of the tubular member. The reusable cup sleeve also has a scannable medium disposed on an outside perimeter of the cup sleeve wherein the scannable medium stores credit card information of a user for payment of select goods.

### CROSS REFERENCE TO RELATED APPLICATIONS

This application claims the benefit of U.S. Provisional Application No. 62/659,405 filed on Apr. 18, 2018. The above identified patent application is herein incorporated by reference in its entirety to provide continuity of disclosure.

### BACKGROUND OF THE INVENTION

The present invention is directed to a beverage insulation sleeve and a method of payment provided thereby. Hot and cold beverages, such as coffee and tea, are typically served in disposable cups with disposable sleeves and disposable lids. However, these disposable cups, sleeves and lids are not manufactured to enable reuse, which can cause many of these parts to be thrown into the garbage, resulting in pollution or other harm to an environment.

Additionally, many hot beverage retailers attract large crowds of customers. Due to these large crowds, it can be difficult for a customer to pay for the beverage in a quick and efficient manner. Failure to pay in a quick and efficient manner can lead to customers becoming frustrated and, in some cases, simply leaving without buying a beverage.

Currently, systems are in place that aim to solve each of these problems individually. On the one hand, a variety of reusable hot beverage containers, including cups, sleeves and lids are prevalent in the marketplace. These products aim to reduce the waste that is associated with the prevalence of single-up hot beverage containers. Though these products do reduce waste, many individuals do not use them because of their size and the fact that they must be carried in the hand of the user.

Also, refillable gift cards and mobile phone applications have been created to provide a faster and more efficient process of paying for an item, such as a beverage. Though these methods have become widespread, there are still several disadvantages associated with them. For example, a mobile phone application may be inaccessible where a customer's phone is not charged.

A few devices utilize expensive and sophisticated technology, such as RFID tags, to provide recognition of the consumer for payment. However, these systems are expensive and do not provide significant convenience to the consumer as these systems may malfunction in a crowded environment where multiple consumers are using similar devices.

Therefore, there is a defined need in the known art for a product and a process that seeks to solve each of these problems, including the bulkiness of reusable beverage containers and accessories and the unreliability of refillable gift cards and mobile phone applications as payment systems.

Devices have been disclosed that generally relate to reusable cup sleeves. These include devices that have been patented and published in patent publications. However, these devices do not disclose a flexible thermally insulated sleeve, wherein the sleeve includes scannable medium thereon, the scannable medium configured to access an existing payment account, allowing a user to pay for a beverage by scanning the scannable medium.

### SUMMARY OF THE INVENTION

In view of the foregoing disadvantages inherent in the known art it is submitted that the present invention substantially diverges in design elements from the prior art and consequently it is clear that there is a need in the art for an improvement to existing reusable cup sleeves. In this regard the instant invention substantially fulfills these needs.

Therefore, it is an object of the present invention to provide a sleeve that is movable between a folded configuration and an unfolded configuration.

It is yet another object of the present invention to provide a sleeve that is flexible, as to fit around a beverage container regardless of the shape of the beverage container.

Another object of the present invention is to provide a sleeve constructed of a thermally-insulated material, such as to prevent the sleeve from absorbing heat from the beverage container.

Another object of the present invention is to provide a sleeve further comprising a radio frequency transmitter, such as to provide alternative payment systems to be utilized.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the reusable cup sleeve.

FIG. 2 shows a planar view of an embodiment of the reusable cup sleeve.

FIG. 3 shows a planar view of an embodiment of the reusable cup sleeve packaged in a gift card.

FIG. 4 shows a perspective view of an embodiment of the reusable cup sleeve in use.

FIG. 5 shows a schematic view of an embodiment of the reusable cup sleeve.

### DETAILED DESCRIPTION OF THE INVENTION

Reference is made herein to the attached drawings. Like reference numerals are used throughout the drawings to depict like or similar elements of the reusable cup sleeve. The figures are intended for representative purposes only and should not be considered to be limiting in any respect. For simplicity and ease of understanding, the following detailed description will describe the reusable cup sleeve with scannable payment system as related to a barcode system, however alternate embodiments including other scannable media, such as, but not limited to, QR codes, magnetic strips, RFID systems, and the like are contemplated.

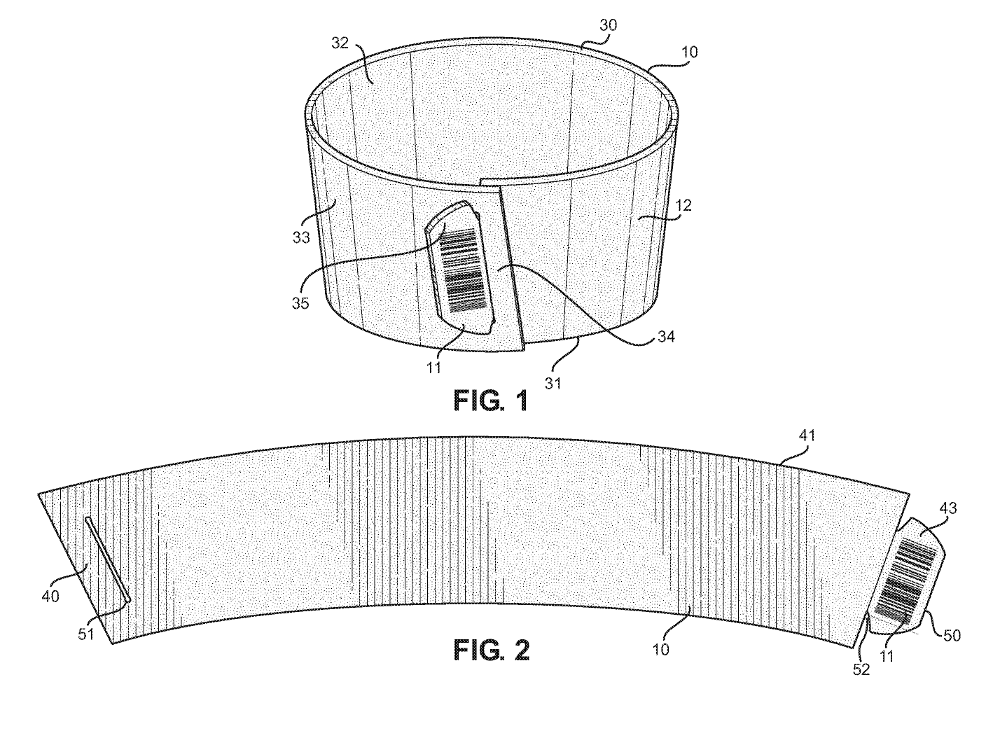

Referring now to FIG. 1, there is shown a perspective view of an embodiment of the reusable cup sleeve. The reusable cup sleeve 10 comprises a sleeve 11 movable between a folded and an unfolded configuration, wherein the unfolded configuration comprises a tubular member 12 having an open upper end 30, an open lower end 31 and a cavity 32 therethrough. The cavity 32 is sized to slidably receive and engage a sidewall of a container when in the folded configuration. In the shown embodiment, the sleeve 11 is made of a recyclable, insulated material, such as paperboard. However, in an alternative embodiment the sleeve 11 can be made of any suitable recyclable and insulated material including washable material, such as, but not limited to, leather, cloth, and the like.

In some embodiments, the reusable cup sleeve 10 further comprises a gripping surface 33 to allow a user to securely hold the container while grasping the sleeve. In one embodiment, the gripping surface 33 comprises an insulated material, the insulated material configured to inhibit the transfer of heat therethrough, thereby allowing the sleeve 10 to remain at a comfortable temperature even when the temperature of the liquid in the container is very hot or cold. In some embodiments, the gripping surface 33 comprises an additional textured layer disposed on an exterior surface of the sleeve 11, the textured layer configured to increase the surface area in contact with a user, thereby providing a secure grip thereto.

In the shown embodiment the sleeve 11 comprises a first side 34 and an opposing second side 35 wherein the first side 34 is adapted to removably engage and secure the second side 35 forming the tubular member 12. In the illustrated embodiment, the reusable cup sleeve 10 comprises a tab (as shown in FIG. 2, 50) removably securable through a slit (as shown in FIG. 2, 51), to secure the second side 35 to the first side 34. In an alternate embodiment, the sleeve 11 comprises a continuous ring forming the tubular member 12.

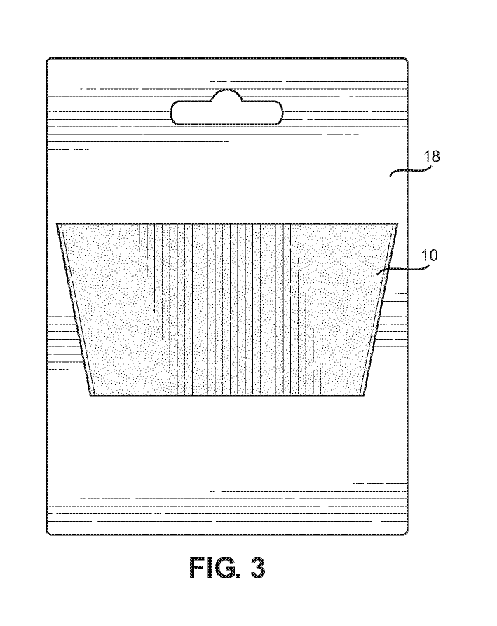

Referring now to FIG. 2 and FIG. 3, there is shown a planar view of an embodiment of the reusable cup sleeve and a planar view of an embodiment of the reusable cup sleeve packaged in a gift card. In the shown embodiment of FIG. 2, the sleeve 11 comprises a front panel 40 and a rear panel 41 in wherein a coded portion 43 is disposed on at least one of the panels 40, 41. In the illustrated embodiment, the coded portion 43 comprises a scannable barcode thereon, wherein the barcode is used to purchase select goods. Furthermore, in the shown in embodiment of FIG. 2, the coded portion 43 is disposed on the second side 35 of the sleeve 11. However, in an alternative embodiment, coded portion 43 is disposed on an exterior surface of the sleeve 11, such as the front or rear panel 40, 41 to allow ease of access during use. In yet another alternate embodiment, the coded portion 43 is disposed on an interior surface of the sleeve 11, such that the coded portion 43 is not exposed during use for security purposes. In the illustrated embodiment of FIG. 2, the sleeve further comprises an arcuate shape, such that the sleeve 11 forms a cylindrical member about a beverage container, wherein the lower end of the sleeve is parallel to the upper end of the sleeve when in the folded configuration. The panels 40, 41 also have a width that is less than the length of the side when in the folded configuration. In this way, the sleeve 11 is configured to removably secure about a circumference of a beverage container, having a width of a hand, such that the user is never in direct contact with the beverage container when the sleeve 11 is removably secured thereto. In the unfolded configuration, the tubular member is flattened and arranged such that no cavity is defined between the open upper end 30 and the open lower end 31.

In the illustrated embodiment of FIG. 2, the second side of the reusable cup sleeve 10 comprises a tab 50 extending therefrom, the tab 50 configured to removably secure through a slit 51 disposed on the first side of the reusable cup sleeve 10. The tab 50 further comprises notches 52 on opposing sides of a base thereof, the notches 52 configured to receive opposing ends of the slit 51 therein. In the illustrated embodiment, the tab 50 further comprises tapered sides having a width greater than that of the slit 51, thereby allowing the tab 50 to fit through the slit 51 upon the application of force, such that the tab 50 cannot easily be removed from the slit 51 without sufficient manipulation thereof. In the illustrated embodiment, the coded portion 43 is disposed on the tab 50, such that when the reusable cup sleeve 10 is removably secured about a beverage container, the coded portion 43 is accessible to a scanning device.

In the shown embodiment of FIG. 3, the reusable cup sleeve 10 is in the folded configuration and adapted to fit securely in a gift card 18 packaging. A user is able to purchase the gift card 18 and use the scannable barcode on the sleeve 11 to purchase a beverage once the coded portion 43 is activated. The user is then able to use the sleeve 18 in the folded configuration to insulate and protect hands from heat or coolness of the beverage. A user activates the coded portion 43 by setting up an account and providing credit card information to a data packet which corresponds to the coded portion 43 of a user's reusable cup sleeve 10, which allows for the purchase of goods when the scannable barcode is scanned for purchase at participating vendors. The sleeve 11 also comprises preprinted indicia on the at least one of the panels 40, 41, wherein the indicia is any selected design and color.

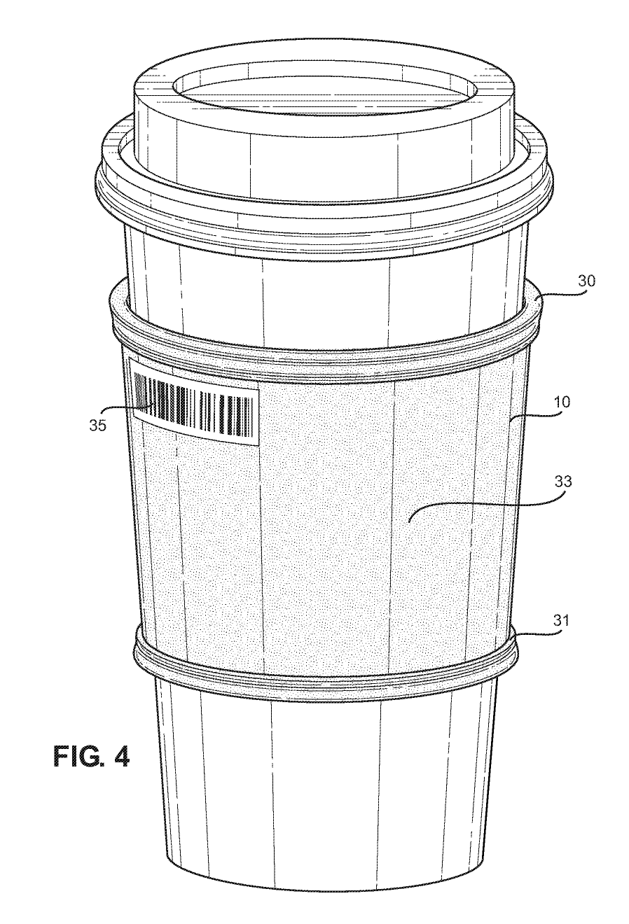

Referring now to FIG. 4, there is shown a perspective view of an embodiment of the reusable cup sleeve in use. In the illustrated embodiment, the barcode is disposed on the opposing second side 35, such that when the sleeve 10 is in the folded configuration, the barcode is exposed to be scanned. The reusable cup sleeve 10 is then placed about a beverage container, such that the beverage container extends through the open upper end 30 and the open lower end 31. In the illustrated embodiment, the reusable cup sleeve 10 is contoured to fit the exterior of the beverage container, such that the reusable cup sleeve 10 is secured thereto via friction fit. Additionally, in the shown embodiment, the open upper end 30 and the open lower end 31 each further comprise a lip extending perpendicularly away from the second side 35. The pair of lips are configured to prevent a user's hand from slipping from the reusable cup sleeve 10, thereby providing the user with a secure gripping surface.

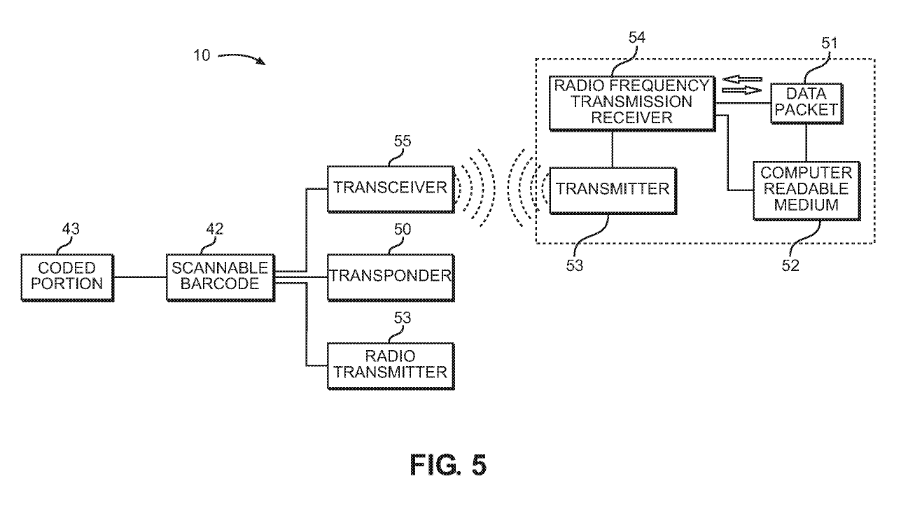

Referring now to FIG. 5, there is shown a schematic view of an embodiment of the reusable cup sleeve. The coded portion 43 further comprises a transponder 50 wherein the transponder 50 is configured to transmit a signal to the data packet 51, which is stored on a computer-readable medium 52. A computer is operably connected to the computer-readable medium 52. The data packet 51 contains the user's personal information, such as name and payment method.

The reusable cup sleeve 10 further comprises a transmitter configured to transmit information linked to the scannable barcode to a coupled receiver. For the purposes of brevity, the following description will utilize a radio transmission system as shown in FIG. 5, however alternate transmission methods capable of transmitting information are also contemplated. In the illustrated embodiment, a radio transmitter 53 configured to correspond to a radio frequency transmission receiver 54, wherein the radio frequency transmitter 53 transmits a unique radio transmission to the corresponding scannable bar code 42 of a designated reusable cup sleeve 10. The unique radio transmission is then received by the radio frequency transmission receiver 54 and accesses the data packet 51, wherein the data packet 51 sends the user's credit card information back to the coded portion 43 for payment of the selected goods. In the shown embodiment, the reusable cup sleeve 10 also comprises a transceiver 55 configured to receive a signal from the data packet 51. In this way, when the user scans the scannable bar code 42, the data packet 51 containing identifying and payment information is accessed, allowing a user to pay for objects similar to a credit, debit, or gift card. Users can modify the payment method by associating it with a specific credit card, bank account, or by simply transferring a discrete amount of funds into the data packet 51, similar to many gift card systems.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A reusable cup sleeve, comprising:
a sleeve movable between a folded and unfolded configuration, wherein the folded configuration comprises a tubular member;
the tubular member defines an open upper end, an open lower end and a cavity therethrough;
wherein the cavity is dimensioned to slidably receive and engage a sidewall of a container therein;
a coded portion disposed on the sleeve with coded information thereon;
a scannable medium disposed on the coded portion wherein the scannable medium is configured to store payment information.

2) The reusable cup sleeve of claim 1, wherein the unfolded configuration is defined where the sleeve is flattened and arranged such that no cavity is defined between the open upper end and the open lower end.

3) The reusable cup sleeve of claim 1 wherein the coded portion further comprises a transponder configured to wirelessly communicate with a remote device.

4) The reusable cup sleeve of claim 3, wherein a data packet containing identifying information corresponding to the coded portion is stored on a computer-readable medium of the remote device.

5) The reusable cup sleeve of claim 1, further comprises a radio frequency transmitter embedded within the sleeve, the radio frequency transmitter configured to correspond to a radio frequency transmission receiver.

6) The reusable cup sleeve of claim 5, wherein the radio frequency transmitter transmits a unique radio transmission to a specific user of the sleeve.

7) The reusable cup sleeve of claim 6 wherein the unique radio transmission is received by the radio frequency transmission receiver and accesses the data packet.

8) The reusable cup sleeve of claim 1, wherein the panels have a width that is less than the length of the sides.

9) The reusable cup sleeve of claim 1, further comprising a slit disposed on a first side of the sleeve, and a tab extending from a second side of the sleeve, wherein the slit is configured to removably secure the tab therethrough.

10) The reusable cup sleeve of claim 9, wherein opposing sides of the tab taper from a base thereof to an upper portion thereof.

11) The reusable cup sleeve of claim 9, wherein the tab further comprises a pair of notches disposed on opposing sides of the tab, the pair of notches configured to engage the slit.

12) The reusable cup sleeve of claim 9, wherein the coded portion is disposed on the tab, such that when the sleeve is in the folded configuration, the coded portion is disposed on an exterior surface of the sleeve.

13) The reusable cup sleeve of claim 1, wherein the sleeve comprises an arcuate shape when in the unfolded configuration.

14) The reusable cup sleeve of claim 1, wherein the open lower end and the open upper end are parallel when in the folded configuration.

15) The reusable cup sleeve of claim 1, wherein the open lower end and the open upper end each further comprise a thickness greater than that of the sleeve.

16) The reusable cup sleeve of claim 1, further comprising a gripping surface disposed on an exterior surface of the sleeve, the gripping surface configured to provide a secure grip to the user.

17) The reusable cup sleeve of claim 16, wherein the gripping surface comprises a coefficient of friction greater than one.
